(19) United States
(12) Patent Application Publication
(10) Pub. No.: US 2014/0006525 A1
(43) Pub. Date: Jan. 2, 2014

(54) SHARING OF MESSAGING INFORMATION

(71) Applicants: Martin Brandt Freund, Mountain View, CA (US); Momchil Filev, Mountain View, CA (US)

(72) Inventors: Martin Brandt Freund, Mountain View, CA (US); Momchil Filev, Mountain View, CA (US)

(73) Assignee: Google Inc., Mountain View, CA (US)

(21) Appl. No.: 13/619,757

(22) Filed: Sep. 14, 2012

Related U.S. Application Data
(60) Provisional application No. 61/666,470, filed on Jun. 29, 2012.

(51) Int. Cl. G06F 15/16

(52) U.S. Cl. 709/206

(57) ABSTRACT

An example method includes receiving, by a first computing device using a text messaging service that allows an exchange of textual messages, a first textual communication sent from a second computing device, where the first computing device has a first unique identifier and the second computing device has a second unique identifier different from the first unique identifier. The method further includes sending, by the first computing device and to the second computing device, a second textual communication using the text messaging service, and combining, by the first computing device, the first textual communication and the second textual communication to form a text message thread. The method further includes sending, by the first computing device, the text message thread to a third computing device, where the third computing device has a third unique identifier that is different from both the first unique identifier and the second unique identifier.

This application claims the benefit of U.S. Provisional Application No. 61/666,470, filed Jun. 29, 2012, which is assigned to the assignee hereof and hereby expressly incorporated by reference herein.

### TECHNICAL FIELD

The present disclosure generally relates to sharing of information using mobile computing devices.

### BACKGROUND

A computing device, such as a mobile device, may provide a user with access to one or more communication channels. Such communication channels may include voice-based telephony, voice over internet protocol (or “VOIP”), text messaging as provided by services such as short messaging service (SMS), messaging as provided by multimedia messaging service (MMS), electronic mail (email), online social networking services, and others. In various examples, a mobile device may provide a user with access to each communication channel through the use of a distinct application installed to the mobile device. As examples, the mobile device may provide access to text and/or multimedia messaging using a messaging application, to email using email client software or an email application, and to online social networking services using social networking applications.

### SUMMARY

In one example, a method includes receiving, by a first computing device using a text messaging service that allows an exchange of textual messages, a first textual communication sent from a second computing device, where the first computing device has a first unique identifier and the second computing device has a second unique identifier different from the first unique identifier. The method further includes sending, by the first computing device and to the second computing device, a second textual communication using the text messaging service, and combining, by the first computing device, the first textual communication and the second textual communication to form a text message thread. The method further includes sending, by the first computing device, the text message thread to a third computing device, where the third computing device has a third unique identifier that is different from both the first unique identifier and the second unique identifier.

In another example, a computer-readable storage device is encoded with instructions that, when executed, cause one or more processors of a first computing device to perform operations. The operations include receiving, by a first computing device using a text messaging service that allows an exchange of textual messages, a first textual communication sent from a second computing device, where the first computing device has a first unique identifier and the second computing device has a second unique identifier different from the first unique identifier. The operations further include sending, by the first computing device and to the second computing device, a second textual communication using the text messaging service, and combining, by the first computing device, the first textual communication and the second textual communication to form a text message thread. The operations further include sending, by the first computing device, the text message thread to a third computing device, where the third computing device has a third unique identifier that is different from both the first unique identifier and the second unique identifier.

In another example, a first device having a first unique identifier includes a memory, at least one processor, a communication interface operable to send and receive messages using a multimedia messaging service (MMS) and a text messaging service, and a control unit. The control unit is operable to cause the communication interface to receive a first communication from a second device and send a second communication to the second device, where at least one of the first communication and second communication is provided by the MMS, and where the second device has a second unique identifier that is different from the first unique identifier. The control unit is further operable to cause the communication interface to combine the first communication and the second communication to form a combined message thread, and send the combined message thread to a third device having a third unique identifier that is different both the first unique identifier and the second unique identifier.

The details of one or more examples of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual diagram illustrating an example system that includes various communicative connections over which computing devices may implement one or more of the techniques of this disclosure.

FIG. 2 is a block diagram illustrating details of an example computing device that implements sharing of messaging information, in accordance with one or more of the techniques of this disclosure.

FIGS. 3A-3D are conceptual diagrams illustrating example user interfaces (UIs) provided by a messaging application that implements one or more sharing techniques of this disclosure.

FIGS. 4A-4B are conceptual diagrams illustrating example user interfaces (UIs) that include messaging information that is shared by implementing one or more techniques of this disclosure.

FIG. 5 is a flowchart illustrating an example process by which a computing device may implement one or more sharing techniques of this disclosure.

### DETAILED DESCRIPTION

A computing device, such as mobile phone or other mobile device, may enable a user to communicate using various data-based communication channels. Examples of such data-based communication channels include short message service (commonly known as “SMS” or “text messaging”), electronic mail (“email”), multimedia message service (“MMS”), social networking (through dedicated applications as well as through browser-based interfaces), voice-over-internet protocol (“VOIP”), and others. In many current implementations, mobile devices provide access to SMS/MMS functionalities through native applications, which are applications that are installed at the time of manufacture or at another time before the mobile device is used by an end user. Mobile devices may also provide access to SMS functionalities through later-installed applications, which may provide user interface (UI) elements and other features different from those of a native messaging (SMS/MMS) application.

In many mobile devices, such as so-called “smartphones,” messaging applications may arrange text messages in a format that resembles several distinct conversations. For instance, a messaging application may arrange all text messages and/or multimedia messages received from, and sent to, a particular phone number in chronological order. By arranging text messages into separate conversations each associated with a particular phone number, the messaging application may generate a number of text message threads, with each text message thread representing a text message-based conversation with a particular phone number.

In terms of arrangement of text messages into threads to simulate conversations, messaging applications may incorporate some advantages and conveniences associated with various applications and browser-based interfaces currently available for email communication. However, these messaging applications may not provide certain features. For example, current messaging applications may not enable a user to add a third participant to a text/multimedia message thread in a manner that provides the third participant context of the conversation thus far, or knowledge of the prior text messages exchanged between the first two participants. Similarly, current messaging applications may not enable a user to forward an entire thread or portions of a thread having more than one text/multimedia message to a third participant.

Another potential limitation of current messaging applications is that they may lack sufficient integration with other applications that enable data-based communications. For example, a messaging application may not enable a user to forward a text/multimedia message thread (or a multi-message portion of a thread) via email. As another example, the messaging application may not use another communication channel as a backup or failsafe measure in case an outgoing text/multimedia message is not successfully delivered.

In general, techniques of this disclosure are directed towards integration of functionalities provided by messaging applications with functionalities provided by other applications with respect to data-based communications. For example, the techniques may enhance existing messaging applications, such that the messaging applications enable a user to add a third participant (and possibly more participants) to an existing message thread, while providing the third participant access to two or more text/multimedia messages exchanged before the third participant was added. The techniques may also enhance messaging applications in such a way that that the messaging applications enable a user to share two or more text/multimedia messages with a select group of people by posting using a social networking website. Additionally, the techniques may enhance existing messaging applications in such a way that the messaging applications enable a user to forward a message thread (or a multi-message portion thereof) to a third participant via email and other data-based communication channels.

The techniques described herein may provide one or more potential advantages. For example, a user may share an entire message thread, or a relevant portion thereof, with a select group of contacts through a social networking website. Another potential advantage is that a user may add participants contextually to an existing message thread in such a manner that the added participants have access to previously exchanged messages. Yet another potential advantage is that a messaging application may interface with other applications, such as an email client, to send a backup communication in addition to a text/multimedia message. In this manner, techniques of the present disclosure may better integrate functionalities of messaging applications with other applications that enable data-based communications, thereby potentially providing a more robust and versatile user experience.

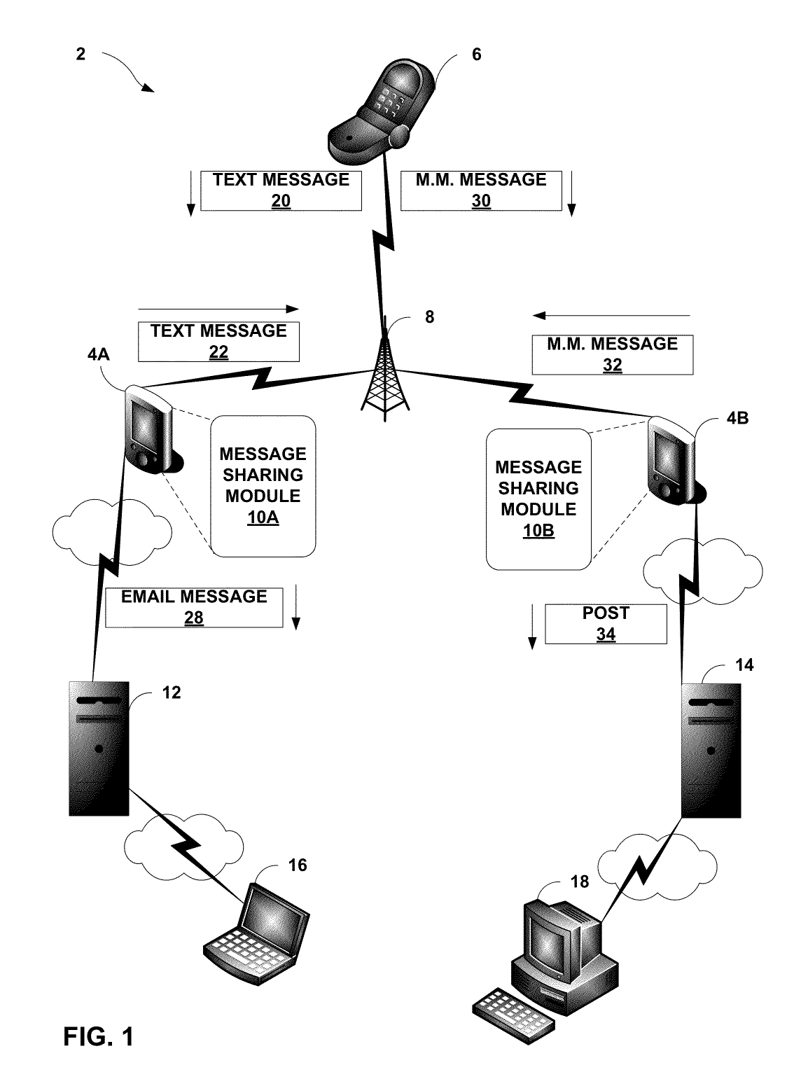

FIG. 1 is a conceptual diagram illustrating an example system 2 that includes various communicative connections over which computing devices may implement one or more of the techniques of this disclosure. As shown in FIG. 1, system 2 includes various types of computing devices, including cellular (“cell”) phone 6, smartphones 4A & 4B, laptop computer 16, and desktop computer 18. Additionally, system 2 includes devices that may manage or administrate communication over these connections, such as cell phone tower 8, email server 12, and social networking server 14. For example, cell phone tower 8 may receive and relay signals to facilitate communication over various cellular networks, such as 3^{rd} Generation (“3G”), 4^{th} Generation (“4G”) and others. The cellular network(s) enabled by cell phone tower 8 may support text messaging services, such as SMS, that allow an exchange of textual messages, multimedia messaging services, such as MMS, that allow an exchange of multimedia messages, voice communications, and others. Similarly, email server 12 may facilitate the exchange of emails, and social networking server 14 may facilitate the exchange of information (e.g., in the form of status updates, private messages, microblogs, message posts, etc.) over the Internet, local area networks (LANs), wide area networks (WANs), metropolitan area networks (MANs), etc. Such networks (and/or various combinations thereof) are illustrated in FIG. 1 using clouds, and not called out for ease of illustration purposes only. It will be appreciated that, while system 2 is illustrated with respect to a particular set of devices for purposes of clarity only, the techniques of this disclosure may apply to systems including a wide variety of devices and elements, some of which are not expressly illustrated in FIG. 1. Additionally, system 2 may be deployed over a private network and/or a single-server network.

Cellular networks, such as one or more cellular networks enabled through cell phone tower 8, may enable users to exchange information through channels other than voice-based communication. In specific implementations, such cellular networks may enable communication through data exchange, such as through the exchange of text messages and multimedia messages described above. For example, any combination of smartphone 4A, smartphone 4B, and cell phone 6 may exchange text messages and/or multimedia messages provided by a text messaging service and/or a multimedia messaging service (MMS), respectively. Similarly, smartphone 4A may exchange emails with laptop computer 16 via email server 12, and smartphone 4B may exchange social network-based data with desktop computer 18 via social networking server 14.

Additionally, each of smartphones 4A & 4B, as well as cell phone 6, may be associated with a unique identifier. Examples of such unique identifiers may include traditional telephone numbers (e.g., a 10-digit sequence in the United States), a so-called “short code” (a numeric sequence shorter than 10 digits), and other messaging identifiers known in the art. Each of smartphones 4A & 4B, as well as cell phone 6 may receive a corresponding unique identifier through the use of a subscriber identity module (SIM), a universal integrated circuit card (UICC), or other device-identifying technologies known in the art.

In the example of FIG. 1, smartphones 4A & 4B include message sharing modules 10A & 10B, respectively. In various implementations, one or both of smartphones 4A & 4B may include multiple modules that work synergistically to perform the functionalities described herein with respect to message sharing modules 10A and/or 10B. In these and other implementations, one or both of message sharing modules 10A & 10B may include various sub-modules that each perform a subset of the functionalities described herein. In this manner, techniques of this disclosure may be implemented through varying configurations of one or more modules, across different devices.

In one example, smartphone 4A may receive a first textual communication, such as text message 20 sent from cell phone 6. Additionally, smartphone 4A may send a second textual communication, such as text message 22, to cell phone 6. In this example, smartphone 4A may combine, or otherwise arrange, text message 20 and text message 22 to form a text message thread. More specifically, smartphone 4A may form the text message thread to display a conversation-like textual representation of the text messages 20 & 22 to a user.

In turn, message sharing module 10A may generate a representation of the text message thread in various readable formats. For example, message sharing module 10A may generate an electronic mail, such as email message 28, that includes a textual representation of the text message thread (e.g., in a conversation-like sequence, with sender identifications such as names, telephone numbers, etc.). Message sharing module 10A may then cause smartphone 4A, or components thereof, to send email message 28 to email server 12. Additionally, email message 28 may be addressed to a unique identifier (e.g., a unique email identifier, such as an email address) associated with a user of laptop computer 16. In this manner, a user of laptop computer 16 may view a text message exchange between users of cell phone 6 and smartphone 4A, in a way that provides the user of laptop computer 16 with a contextual understanding of the text message exchange.

In addition, message sharing module 10A may be configured to receive communications and convert the received communications to text message formats, such as a format conforming to SMS standards. For example, a user of laptop computer 16 may send an email response after reading email message 28. Smartphone 4A may receive the reply email from email server 12, or otherwise access the email response by contacting email server 12. Message sharing module 10A may convert portions of the email response (e.g., the body of the email response, the subject line, etc.) to a text message format, and append the resulting text message to the text message thread that includes text messages 20 & 22. In this manner, message sharing module 10A may implement techniques of this disclosure to enable participation in a text message-based conversation through the use of communication channels other than text messaging, such as email.

In another example, smartphone 4B may receive a first communication, such as multimedia message 30 sent from cell phone 6. Additionally, smartphone 4B may send a second communication, such as multimedia message 32, to cell phone 6. As described above with respect to smartphone 4A, smartphone 4B may combine multimedia messages 30 & 32 to form a combined message thread. In various implementations, the combined message thread may include visual representations of multimedia messages 30 & 32 in chronological order (e.g., arranged in order of oldest sent to most recently sent). Each of multimedia messages 30 & 32 may include various combinations of textual and non-textual data, such as images, videos, audio data, etc. Multimedia messages 30 & 32 may also include certain types of textual data that are not supported by text messaging services, such as richly formatted text, and others.

Message sharing module 10B may cause smartphone 4B to send the combined message thread to a third device in a format other than formats supported by MMS. Additionally, message sharing module 10B may cause smartphone 4B to send the formatted over a communication channel other than MMS-based channels. In other words, message sharing module 10B may implement techniques of this disclosure to enable cross-channel sharing of messaging information.

In one example, message sharing module 10B may generate a visual representation (such as a social networking “post” or “update”) of the combined message thread. In this example, message sharing module 10B may cause smartphone 4B to send the visual representation (e.g., post 34) to social networking server 14. Additionally, smartphone 4B may send post 34 from a user account associated with a user of smartphone 4B. In this scenario, message sharing module 10B may generate post 34 such that post 34 includes an indication that social networking server 14 is to display post 34 in association with the user account.

In some examples, message sharing module 10B may select a subset of contacts associated with the user account, to which post 34 is to be visible. For example, the user account associated with the user of smartphone 4B may be linked to multiple contacts through an online social networking service hosted by social networking server 14. Each contact may be associated with a separate user account. In turn, message sharing module 10B may select (e.g., in response to a user input) a subset of these multiple contacts. Based on the selected subset, message sharing module 10B may generate post 34 to include an indication of the selected subset. In various examples, the subset may correspond to a predetermined classification (such as a “co-workers” or “family” subset) associated with the user account. In other examples, the subset may correspond to a new selection of contacts (e.g., through user input). In this manner, message sharing module 10B may implement techniques of this disclosure to enable selective cross-channel sharing of messaging information.

Smartphone 4B may send post 34 (with or without constraints on selected contact subsets, as the case may be) to social networking server 14. In turn, social networking server 14 may provide a user of desktop computer 18 with access to post 34. For example, the user may be logged on to a corresponding user account from desktop computer 18. The corresponding user account may be a contact linked to the user account associated with the user of smartphone 4B. Thus, by viewing post 34 (e.g., through a browser-based web interface to the social networking service hosted by social networking server 14), the user of desktop computer 18 may contextually view the multimedia message conversation between users of smartphone 4B and cell phone 6.

Additionally, message sharing module 10B may enable the user of desktop computer 18 to participate in the multimedia message conversation. For example, the user of desktop computer 18 may add a comment to post 34, using the online social networking service hosted by social networking server 14. Message sharing module 10B may convert portions of the comment to a format conforming to MMS standards, and add the converted comment portions to the combined message thread. Smartphone 4B may then present the combined message thread (updated with the converted comment) to a user through the use of one or more message-reader applications.

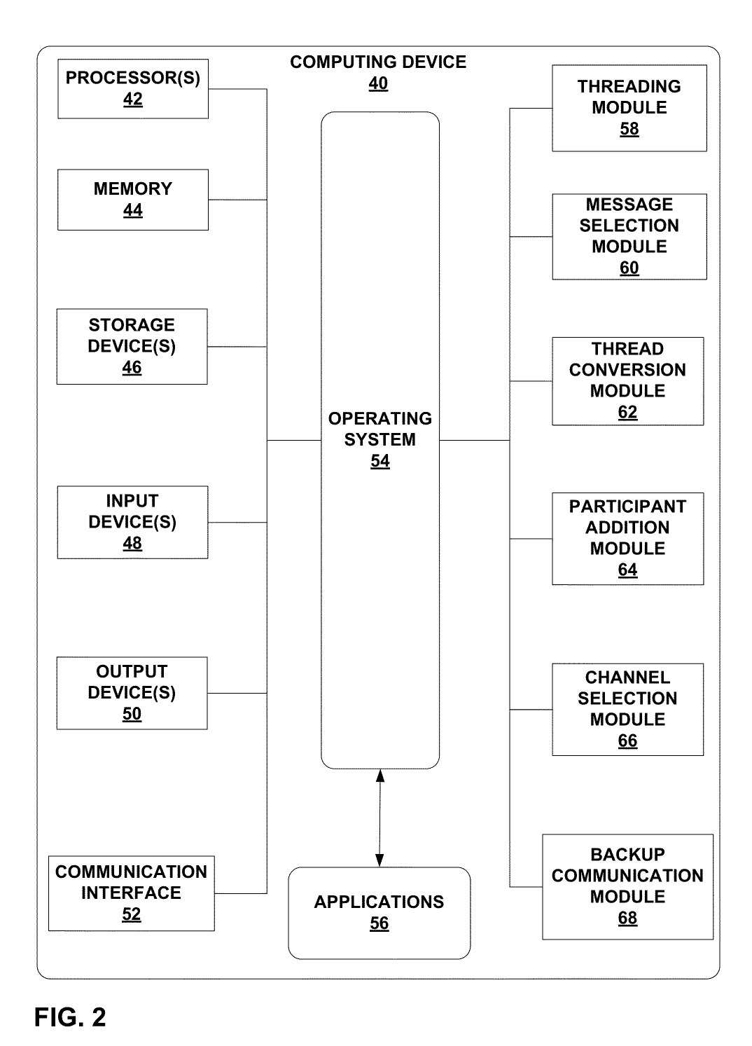

FIG. 2 is a block diagram illustrating details of an example computing device 40 that implements sharing of messaging information, in accordance with one or more aspects of this disclosure. Computing device 40 may be one non-limiting implementation of one or both of smartphones 4A & 4B illustrated in FIG. 1. As shown in the example of FIG. 2, computing device 40 includes one or more processors 42, memory 44, one or more storage devices 46, one or more input devices 48, one or more output devices 50, and communication interface 52. One or more processors 42 are, in some examples, configured to implement functionality and/or process instructions for execution within computing device 40. For example, processors 42 may process instructions stored in memory 44 and/or instructions stored on storage devices 46. Such instructions may include components of operating system 54, threading module 58, message selection module 60, thread conversion module 62, participant addition module 64, channel selection module 66, backup communication module 68, and/or one or more applications 56. Computing device 40 may also include one or more additional components not shown in FIG. 2, such as a power supply (e.g., a battery), a global positioning system (GPS) receiver, and a radio frequency identification (RFID) reader, among others.

Memory 44, in one example, is configured to store information within computing device 40 during operation. Memory 44, in some examples, is described as a computer-readable storage medium. In various examples, memory 44 may be described as one or more of a tangible computer-readable storage medium, a non-transitory computer-readable storage medium, and a computer-readable storage device. In some examples, memory 44 is a temporary memory, meaning that a primary purpose of memory 44 may not be long-term storage. Memory 44, in some examples, is described as a volatile memory, meaning that memory 44 does not maintain stored contents when memory 44 is not receiving power. Examples of volatile memories include random access memories (RAM), dynamic random access memories (DRAM), static random access memories (SRAM), and other forms of volatile memories known in the art. In some examples, memory 44 is used to store program instructions for execution by processors 42. Memory 44, in one example, is used by software (e.g., operating system 54) or applications (e.g., one or more applications 56) executing on computing device 40 to temporarily store information during program execution.

One or more storage devices 206, in some examples, also include one or more computer-readable storage media. In some examples, storage devices 206 may be configured to store greater amounts of information than memory 44. Storage devices 206 may further be configured for long-term storage of information. In some examples, storage devices 206 include non-volatile storage elements. Examples of such non-volatile storage elements include magnetic hard discs, optical discs, solid-state discs, floppy discs, flash memories, forms of electrically programmable memories (EPROM) or electrically erasable and programmable memories, and other forms of non-volatile memories known in the art.

As shown in FIG. 2, computing device 40 may also include one or more input devices 48. One or more of input devices 48 may be configured to receive input from a user through tactile, audio, video, or biometric channels. Examples of input devices 48 may include a keyboard, mouse, touchscreen, presence-sensitive display, microphone, one or more still and/or video cameras, fingerprint reader, retina scanner, or any other device capable of detecting an input from a user or other source, and relaying the input to computing device 40, or components thereof.

Output devices 50 of computing device 40, in some examples, may be configured to provide output to a user through visual, auditory, or tactile channels. Output devices 50 may include a video graphics adapter card, a liquid crystal display (LCD) monitor, a light emitting diode (LED) monitor, a cathode ray tube (CRT) monitor, a sound card, a speaker, or any other device capable of generating output that may be intelligible to a user. Output devices 50 may also include a touchscreen, presence-sensitive display, or other input/output capable displays known in the art.

Computing device 40, in various implementations, also includes communication interface 52. Computing device 40, in one example, utilizes communication interface 52 to communicate with external devices via one or more networks, such as one or more wireless networks. Communication interface 52 may be a communication interface card, such as an Ethernet card, an optical transceiver, a radio frequency transceiver, or any other type of device that can send and receive information. Other examples of such communication interfaces may include Bluetooth®, 3G, 4G, and WiFi® radios in mobile computing devices as well as USB. In some examples, computing device 40 utilizes communication interface 52 to wirelessly communicate with external devices over a network.

Operating system 54 may control one or more functionalities of computing device 40 and/or components thereof. For example, operating system 54 may interact with applications 56, and may facilitate one or more interactions between applications 56 and one or more of processors 42, memory 44, storage devices 46, input devices 48, and output devices 50. As shown in FIG. 2, operating system 54 may interact with or be otherwise coupled to applications 56, threading module 58, message selection module 60, thread conversion module 62, participant addition module 64, channel selection module 66, and backup communication module 68. In some examples, one or more of threading module 58, message selection module 60, thread conversion module 62, participant addition module 64, channel selection module 66, and backup communication module 68 may be included in operating system 54. In these and other examples, threading module 58, message selection module 60, thread conversion module 62, participant addition module 64, channel selection module 66, and backup communication module 68 may be part of applications 56. In other examples, one or more of threading module 58, message selection module 60, thread conversion module 62, participant addition module 64, channel selection module 66, and backup communication module 68 may be implemented externally to computing device 40, such as at a network location. In some such instances, computing device 40 may use communication interface 52 to access and implement functionalities provided by the illustrated modules and their respective components, through methods commonly known as “cloud computing.”

Threading module 58 may be configured or otherwise operable to combine individual communications (such as textual communications and multimedia messages) into distinct, conversation-like “threads.” For example, if computing device 40 communicates with a second computing device (not shown for purposes of clarity only) through the exchange of text messages, threading module 58 may arrange the exchanged text messages to form a text message thread that resembles a conversation between the respective users of computing device 40 and the second computing device. Similarly, if computing device 40 communicates with a third computing device by exchanging a combination of text messages and multimedia messages, threading module 58 may combine the exchanged messages to form a combined message thread. The text message thread with respect to the second computing device and the combined message thread with respect to the third computing device may be stored separately from one another (e.g., to storage devices 46), in order to reflect separate message-based conversations.

Message selection module 60 may be configured or otherwise operable to select portions of a message thread to share with a computing device that was not previously involved in the message thread. For example, message selection module 60 may select a portion of the combined message thread reflecting the text message exchange between computing device 40 and the second computing device, for sharing with the third computing device. In examples, message selection module 60 may select a portion of the message thread based on a user input that indicates a desired length of the text message thread. For example, a user may enter the desired length of the text message through the use of one or more of input devices 48. The user may indicate the desired length in various terms, including a maximum number of communications (e.g., textual communications, multimedia messages, etc.), a time period or timeline including a cut-off date associated with an oldest and/or newest desired communication in the thread, specific message identifiers, and others.

Message selection module 60 may select the portions of the thread based on the desired length indicated in the user input. In other words, message selection module 60 may select the messages such that the resulting thread does not exceed the desired length indicated in the user input. As one illustrative example, message selection module 60 may select all messages of the thread that are time-stamped after a cut-off date indicating an oldest desired message. As another illustrative example, message selection module 60 may select a range of messages of the thread that are time-stamped after the cut-off indicating the oldest desired message and before a cut-off date indicating a newest desired message. As yet another illustrative example, message selection module 60 may select a desired number of messages as indicated in the user input (e.g., a number of messages from an oldest message onward, from a newest message backward, a number of messages in a particular message range, etc.). In still another example, such as in a default scenario, message selection module 60 may select all messages of the thread. In this manner, message selection module 60 may select portions of a thread based on various parameters, while also implementing default message selection options.

As shown in FIG. 2, computing device 40 may also include thread conversion module 62. Thread conversion module 62 may be configured or otherwise operable to convert the thread portions selected by message selection module 60 to one or more readable formats. As described with respect to FIG. 1, thread conversion module 60 may convert the selected thread portions to formats including email, posts conforming to various social networking service standards, and others. Additionally, thread conversion module 60 may convert the selected thread portions to another message thread (e.g., in a text messaging and/or multimedia messaging format). In examples where the selected message thread portions include multimedia messages, the emails, posts, etc. may include multimedia data such as video and/or audio data. Additionally, thread conversion module 60 may cause computing device 40 to output the converted message thread, e.g., by displaying the converted message thread through a display device of output devices 50. In this manner, thread conversion module 60 may convert selected message thread portions to various formats that are readable to a variety of devices.

Computing device 40 may further include participant addition module 64. Participant addition module 64 may be configured or otherwise operable to add one or more additional participants to an existing message thread. As discussed, techniques of this disclosure may enable the addition of a third participant to an existing message thread between first and second participants, thereby providing the third participant with a contextual understanding of the conversation thus far. For example, participant addition module 64 may add a third participant to the text message thread between computing device 40 and the second computing device. Participant addition module 64 may add the third participant in response to various stimuli, such as a user input received via input devices 48, a particular type of message (e.g., an invitation) sent from computing device 40 to a device used by the third participant, an incoming message from the third participant requesting to join the text message thread, and others. In one example, participant addition module 64 may receive a textual communication from the device used by the third participant, and thread conversion module may generate a communication (such as a text message or a multimedia message) that includes the message thread. Computing device 40 may then send the generated communication to the device used by the third participant (e.g., using the text messaging service or the MMS).

In certain examples, participant addition module 64 may work in conjunction with message selection module 60 to provide the added participant with access to certain selected portions of the text message thread. For example, participant addition module 64 and/or message selection module 60 may select those messages of the text message thread that are pertinent to a conversation with the added participant. Conversely, participant addition module 64 and/or message selection module 60 may omit certain messages that are irrelevant to a conversation with the added participant. As one illustrative example, where the added participant is a third party collaborator on a work-related project, participant addition module 64 and/or message selection module 60 may select only those messages that pertain to the work-related project.

In various implementations, computing device 40 may include channel selection module 66. Channel selection module 66 may be configured or otherwise operable to select one or more communication channels over which to share messaging information provided by text messages and/or multimedia messages. In examples, channel selection module 66 may select communication channels including email, online social networking services, text messaging services, MMS, and others. In some instances, channel selection module 66 may select multiple communication channels over which to send a particular message thread (or portions thereof).

As shown in FIG. 2, computing device 40 may also include backup communication module 68. Backup communication module 68 may be configured or otherwise operable to cause computing device 40 send a message, or a portion of a message thread, over two or more communication channels. As one example, backup communication module 68 may cause computing device 40 to send a text message to the second computing device, and also send a textual representation of the text message as part of an email message to an email server, such that the email message is addressed to a user of the second computing device. By sending both the text message as well as the email message, backup communication module 68 may enable a robust communication of information between computing device 40 and the second computing device. More specifically, backup communication module 68 may provide a second mode of communication (or a failsafe option) in case a first mode of communication over a first channel is unsuccessful.

In some examples, backup communication module 68 may send the backup communication (e.g., the email message) if certain conditions apply. For example, backup communication module 68 may set a predetermined time limit within which a text message or multimedia message is expected to be delivered to the second computing device. If the text/multimedia message is not sent successfully within the predetermined time limit, backup communication module 68 may send the email message to the email server. Conversely, if backup communication module 68 determines that the text/multimedia message was sent successfully within the predetermined time limit, backup communication module 68 may decline to send the email message to the email server.

In various implementations, backup communication module 68 may send a backup communication (e.g., text message, multimedia message, email message, etc.) to an emergency contact associated with a user of the second computing device. For example, if backup communication module 68 determines that a text message was not sent successfully to the second computing device, backup communication module 68 may send a backup text/multimedia message to a device used by the emergency contact. In various examples, the backup message may be a copy of the original text message, a message addressed to the emergency contact that encapsulates the original text message, an alert message to the emergency contact, and others. Additionally, backup communication module 68 may itself choose the emergency contact, use an emergency contact designated by the user of the second computing device, use an emergency contact stored to or accessible by computing device 40, etc. In this manner, techniques of this disclosure may enable the distribution of possible emergency information in the event that an original text/multimedia message is not sent successfully within a predetermined time limit.

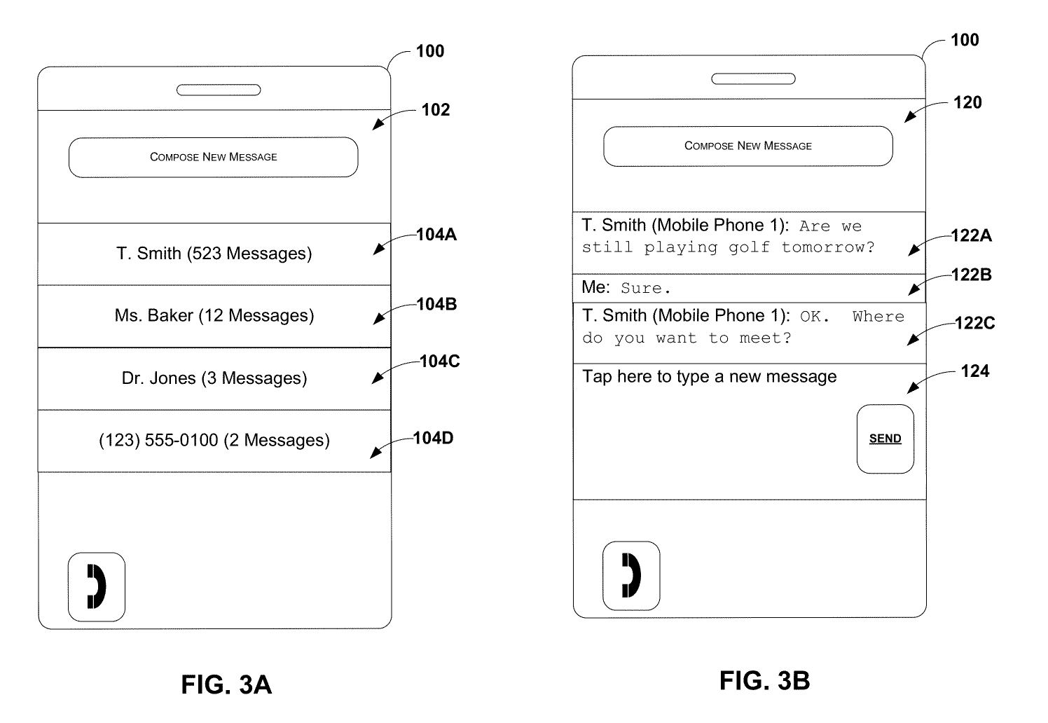

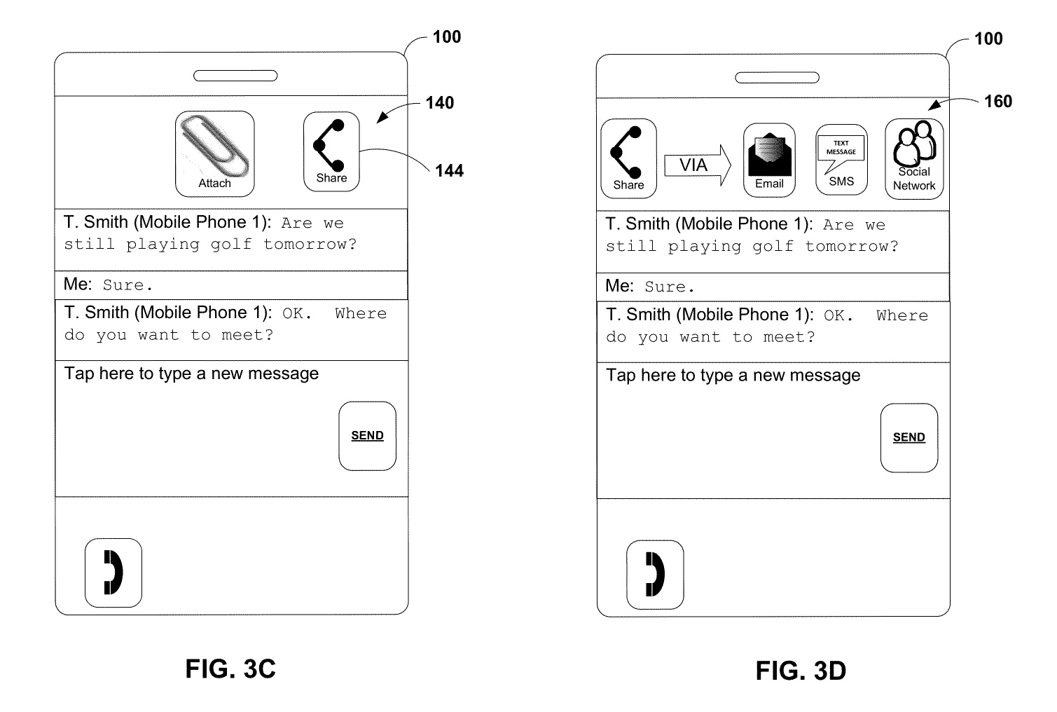

FIGS. 3A-3D are conceptual diagrams illustrating example user interfaces (UIs) provided by a messaging application that implements one or more sharing techniques of this disclosure. The UIs of FIGS. 1A-1D are illustrated as being provided by mobile computing device 100. Mobile computing device 100 may include, be, or be part of one or more of a variety of types of devices, such as a mobile phone (including a smartphone), tablet computer, netbook, ultrabook, laptop, personal digital assistant (“PDA”), and watch, among others. Additionally, mobile computing device 100 may be a non-limiting example of one or more of smartphones 4A & 4B of FIG. 1 and computing device 40 of FIG. 2. Mobile computing device 100 may output UIs for display through a variety of display devices, such as a presence-sensitive display, touchscreen, or any other input/output capable device. Although mobile computing device 100 may use any one or more of the display devices listed above, for ease of discussion, mobile computing device 100 will be described with respect to a touchscreen.

FIG. 3A illustrates mobile computing device 100 in state where a user may select an existing message thread or start a new message thread (e.g., using the “compose new message” button, which is not called out for purposes of clarity only). Mobile computing device 100 may be one non-limiting example of various devices described herein, such as smartphones 4A & 4B of FIG. 1, and computing device 40 of FIG. 2. Specifically, in the example of FIG. 3A, mobile computing device 100 outputs, at the touchscreen, first graphical user interface (GUI) 102. In turn, first GUI 102 includes a visual representation of message threads 104A-104D (“threads 104”), as well as other common GUI elements, including interactive buttons that enables a user to compose a new text/multimedia message and to place a phone call (not called out for purposes of clarity only). In several scenarios, GUI 102 may include a representation of a messaging application. Examples of messaging applications may include a native messaging application (e.g., an application installed at or shortly after manufacture and/or provisioning of mobile computing device 100), an after-market application (e.g., an application installed to mobile computing device 100 by a user), etc.

As discussed, various messaging applications may arrange message exchanges into distinct, conversation-like threads. In the example of FIG. 3A, each of threads 104 may represent a message-based conversation between mobile computing device 100 and another distinct device. Additionally, each of threads 104A-104C may represent a message-based conversation with a device that is pre-identified by mobile computing device 100. More specifically, mobile computing device 100 may store a saved contact identifier linked to telephone numbers and/or short codes that are associated with particular devices. For example, a user may store, to a storage device accessible to mobile computing device 100, saved contact identifiers titled “T. Smith,” “Ms. Baker,” and “Dr. Jones.”

As one illustrative example, the “T. Smith” saved contact identifier may be linked to a telephone number. Mobile computing device 100 may use the saved contact identifier to choose the telephone number to which to send a message. Conversely, mobile computing device 100 may choose a saved contact identifier based on an origination telephone number of a received message. In contrast, message thread 104D may include message exchanged with a device for which mobile computing device does not have a saved contact identifier. Consequently, message thread 104D is identified by a generic telephone number. Additionally, in the specific example of FIG. 3A, the messaging application may indicate a number of messages included in each of threads 104.

FIG. 3B illustrates mobile computing device 100 in a state in which a user may view the most recent messages of a selected message thread, and send new messages as part of the selected message thread. FIG. 3B illustrates second GUI 120. Second GUI 120 may include a visual representation associated with the messaging application when a user views the text messages exchanged as part of message thread 104A. In examples, a user may invoke second GUI 120 by interacting with first GUI 102, such as by tapping on an area of the touchscreen associated with message thread 104A. More specifically, second GUI 120 includes text messages 122A-122C (“messages 122”). To resemble a conversation, the messaging application may identify each of messages 122 according to the sender (e.g., “me” for mobile computing device 100, and the saved contact identifier “T. Smith” for the device identified as “T. Smith”). In the specific example of FIG. 3B, the received messages are identified by a “mobile phone 1” associated with the T. Smith saved contact (e.g., other contact information, such as a second mobile phone, may also be linked to the T. Smith saved contact identifier). Other message identification techniques, such as arrangement of messages in two columns, are also known in the art. Additionally, second GUI 120 may include text entry box 124, through which a user of mobile computing device 100 may compose another message to the device identified by “T. Smith (Mobile Phone 1).”

FIG. 3C illustrates mobile computing device 100 in a state where a user may invoke various optional actions with respect to a selected message thread, including an option to share all or a portion of the selected message thread. FIG. 3C illustrates third GUI 140. A user may invoke third GUI 140 by interacting with mobile computing device 100, such as by pressing a button of mobile computing device 100, pressing and holding a portion of the touchscreen, etc. In turn, third GUI 140 may include one or more GUI elements, such as share button 144, through which a user may avail of one or more functionalities provided by the techniques described herein. In examples, a user may avail of the functionalities by tapping an area of the touchscreen associated with share button 144, pressing and holding the area of the touchscreen associated with share button 144, and others.

FIG. 3D illustrates mobile computing device 100 in a state where the user may select one or more channels over which to share all or a portion of the selected message thread. FIG. 3D illustrates mobile computing device outputting fourth GUI 160 via the touchscreen. As discussed, a user may invoke fourth GUI 160 by selecting share button 144 illustrated in FIG. 3C. As shown in FIG. 3D, fourth GUI 160 may include GUI elements corresponding to several sharing options, such as email, text messaging, and social network-based sharing (not called out separately for ease of illustration purposes only). In various implementations, fourth GUI 160 may include elements associated with other sharing options, such as through multimedia messaging, etc.

A user may avail of the message sharing techniques of this disclosure by selecting one or more of the sharing options presented in fourth GUI 160. As described, the user may share a portion of message thread 104A over various channels. As examples, the user may share a portion of message thread 104A over email by selecting the “email” button, over a text messaging service by selecting the “SMS” button, over an online social networking service by selecting the “Social Network” button, etc. In each scenario listed above, the user may select one or more recipients to which to send the portion of text message thread 104A. In the example of sharing over email, the user may specify one or more email addresses to which to send the selected portion of text message thread 104A. In the example of sharing over an online social networking service, the user may select specific contacts, specific groups (or subsets) of contacts, etc., with which to share the selected portion of text message thread 104A. Similarly, in the example of sharing over the text messaging service, the user may specify unique identifiers of devices with which to share the selected portion of text message thread 104A. In various examples, sharing over these channels may enable adding one or more additional participants to text message thread 104A.

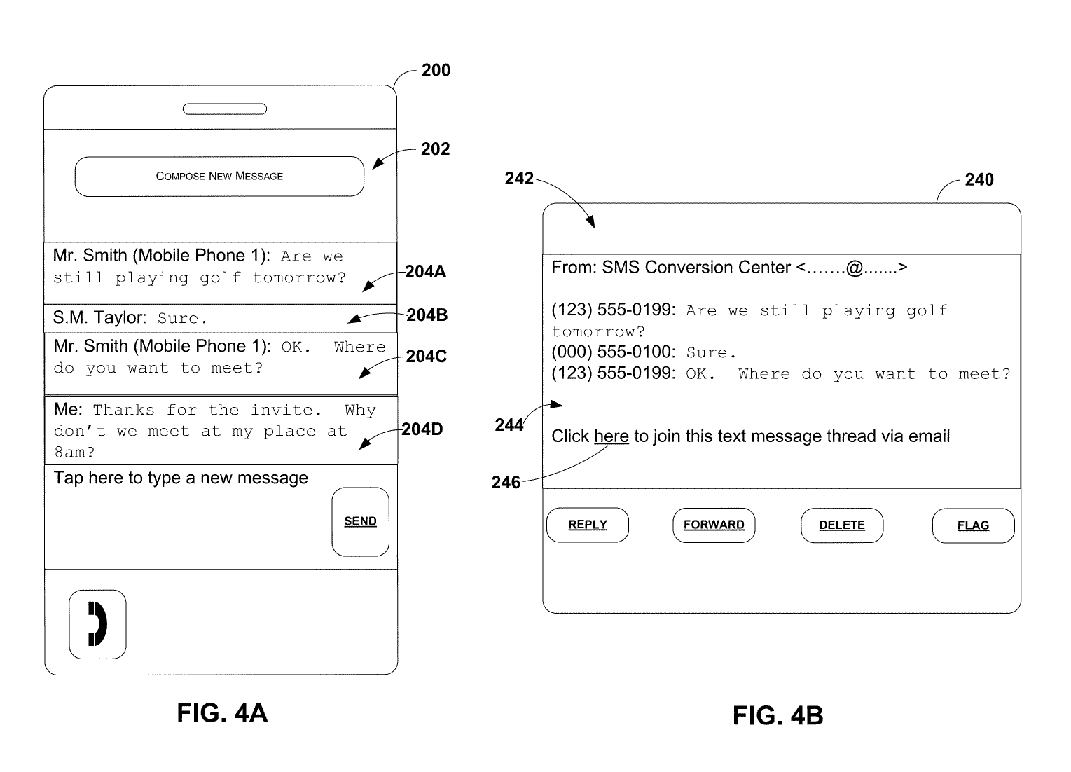

FIGS. 4A-4B are conceptual diagrams illustrating example user interfaces (UIs) that include messaging information that is shared by implementing one or more techniques of this disclosure. More specifically, FIGS. 4A-4B illustrate UIs provided for display by computing devices that may receive message information shared by, for example, mobile computing device 100 of FIGS. 3A-3D. The computing devices of FIGS. 4A-4B may be capable of receiving, processing, and transmitting communications over various types of communication channels, including channels over which techniques of this disclosure enable sharing of text and/or multimedia messaging information.

FIG. 4A illustrates computing device 200 in a state where a user may be added to an existing message thread between two other users, and participate, via text messaging and/or MMS, in the existing message thread as an added (e.g., third) participant. Computing device 200 may be one non-limiting example of various devices described herein, such as smartphones 4A & 4B of FIG. 1, and computing device 40 of FIG. 2. FIG. 4A illustrates computing device 200 that may receive text and/or multimedia messaging information, and present the received information for display. Computing device 200 may, in various examples, be a mobile device such as a smartphone. Additionally, computing device 100 may be a non-limiting example of one or more of smartphones 4A & 4B of FIG. 1 and computing device 40 of FIG. 2. In the instance of FIG. 4A, computing device 200 provides for display, a visual representation associated with the messaging application when a user views the text messages exchanged as part of a text message exchange (similar to second GUI 140 of FIG. 3B). For purposes of illustration, the text messages illustrated in FIG. 4A may represent text message thread 104A of FIGS. 3A-3D. In the instance of computing device 200, mobile computing device 100 of FIGS. 3A-3D may be linked to a saved contact identifier titled “S. M. Taylor.” Similarly, the device identified as “T. Smith (Mobile Phone 1)” by computing device 100 may be linked to a saved contact identifier titled “Mr. Smith (Mobile Phone 1)” stored to computing device 200.

As shown in FIG. 4A, messages 204A-204C may represent messages already exchanged between computing device 100 and another device. As a result, messages 204A-204C may provide a user of computing device 200 with context and background regarding text message thread 104A. Additionally, computing device 200 may participate in the message thread. As shown, computing device 200 may send text message 204D, which may be delivered to one or more devices already participating in the message thread. Text message 204D is also included in the same thread as text messages 204A-204C, thus enabling a user of computing device 200 to communicate as an added participant in an existing or ongoing message thread.

FIG. 4B illustrates computing device 240 in a state where a user may be added to an existing message thread between two or more users via email, and participate in the existing message thread using channels such as email and/or other browser-based or application-based channels. Computing device 240 may be one non-limiting example of various devices described herein, such as smartphones 4A & 4B of FIG. 1, and computing device 40 of FIG. 2. FIG. 4B illustrates computing device 240 that may receive information as part of an email message, and present the received information for display. Computing device 240 may include, be, or be part of a variety of devices capable of displaying email content. Additionally, computing device 240 may be a non-limiting example of one or more of smartphones 4A & 4B, laptop computer 16, and desktop computer 18 of FIG. 1, and computing device 40 of FIG. 2. In the example of FIG. 4B, computing device 240 outputs, for display, GUI 242. In turn, GUI 242 may include a visual representation of text message thread 104A, as part of email 244.

As shown, in the specific example of FIG. 4B, neither computing device 240 nor an email server providing email message 244 has linked the senders of the text messages to saved contact identifiers. As a result, each text message of text message thread 104A is identified by a phone number. In this example, a user of computing device may join the text message thread (e.g., become an additional participant), by clicking on link 246, and entering text where and when prompted. In this manner, one or more techniques of this disclosure may enable a user to become an additional participant in a text and/or multimedia message thread using a variety of communication channels.

As discussed, the techniques of this disclosure may also be implemented in a variety of messaging services and protocols. For example, the techniques may be implemented when exchanging messages over a text message service that defines a maximum number of characters for a single textual communication. Similarly, the techniques may be implemented in conjunction with text messaging services that offer text message concatenation to enhance the number of characters that a user is able to send. Additionally, the techniques may be implemented in conjunction with MMS. As one example, email 244 may include one or more of images, video data, audio data, or links to one or more of images, video data, and audio data. In this manner, the message sharing techniques of this disclosure may be implemented in conjunction with a wide variety of messaging services, formats, and protocols.

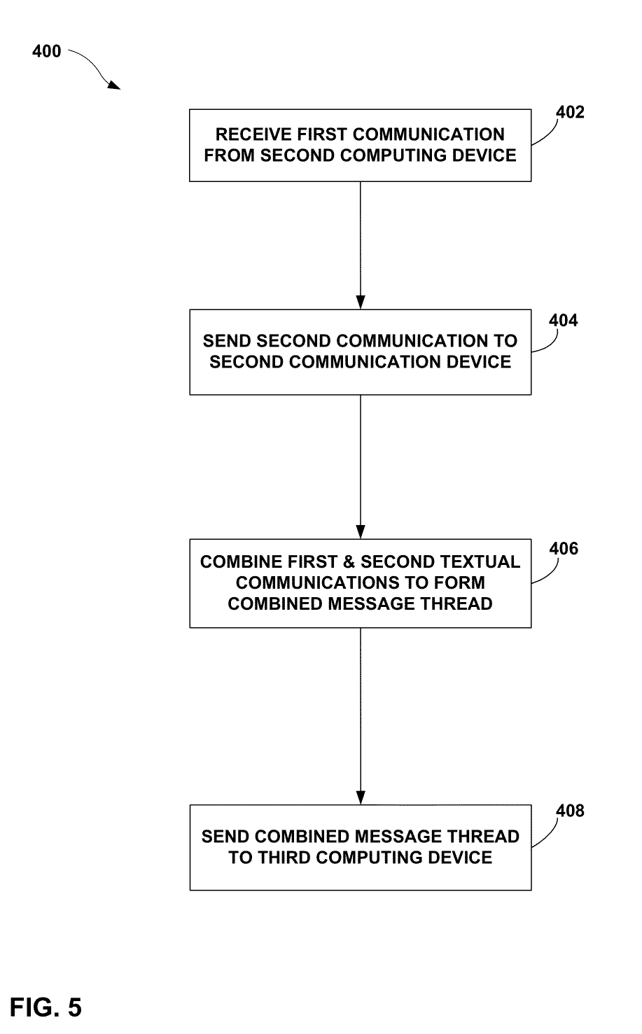

FIG. 5 is a flowchart illustrating an example process 400 by which a computing device may implement one or more sharing techniques of this disclosure. Although process 400 may be performed by a wide variety of devices to implement the techniques, for ease of discussion purposes only, process 400 is described herein with respect to computing device 40 of FIG. 2. Process 400 may begin when computing device 40 receives (e.g., using communication interface 52) a first communication from a second computing device (402). In various examples, the first communication may be selected from at least one of a text message provided by a text messaging service and a multimedia message provided by a multimedia messaging service (MMS). Additionally, computing device 40 may send a second communication to the second communication device (404). As described with respect to the first communication received by computing device 40, the second communication may be selected from at least one of a text message provided by the text messaging service and the multimedia message provided by the MMS.

Computing device 40 may combine the first communication and the second communication to form a combined message thread (406). As described, the combined message thread may be structured to resemble a conversation between respective users of computing device 40 and the second computing device. Additionally, computing device 40 may send the combined message thread to a third computing device (408). As described, computing device 40 may send the combined message thread to the third computing device using a variety of communication channels, including email, text messaging services, MMS, social networking services, and others.

In one example, computing device 40 may generate an email message including a graphical representation of the combined message thread (and/or a visual representation of the combined message thread), and send the email message to an email server, where the email message is addressed to a unique email identifier associated with a user of the third computing device. In some examples, computing device 40 may send the graphical representation of the combined message thread and/or the visual representation of the combined message thread to a server that hosts a social networking service (e.g., an online social networking service). In some such examples, computing device 40 may send the graphical representation and/or the visual representation to server hosting the social networking service by sending the graphical representation and/or the visual representation from a user account associated with computing device 40, indicating that the server is to display the representation(s) in association with the user account. In some such examples, computing device 40 may select a subset of contacts from a plurality of contacts associated with the user accounts, where each contact is associated with a separate user account, and send an instruction to the social networking server to display the representation(s) to only the selected subset of contacts.

In one example, computing device 40 may receive a third communication (such as a textual communication or a multimedia message), generate a fourth communication that includes the combined message thread (e.g., a text message thread), and send the fourth communication using the text messaging service or MMS. In some examples, computing device 40 may receive a user input that indicates a desired length of the text/combined message thread, and combining the first and second communications may include forming a text/combined message thread such that the text/combined message thread does not exceed the desired length indicated in the user input. In one such example, the user input may indicate the desired length as a maximum number of communications (e.g., textual communications and/or multimedia messages) in the text/combined message thread. In another such example, the user input may indicate the desired length as a timeline with a cut-off date associated with the oldest desire communication (textual, multimedia, etc.) in the text/multimedia thread.

In some examples, computing device 40 may send the text/combined message thread to a third computing device by sending a third textual/multimedia communication to the third computing device, and send an email message to an email server, where the email message includes a textual/graphical/visual representation of the text/combined message thread, and where the email message is addressed to a unique email identifier associated with a user of the third computing device. In one such example, computing device 40 may determine whether the third communication was sent successfully to the third computing device within a predetermined time limit, and if the third communication was not sent successfully within the predetermined time limit, send the email message to the email server. In another such example, the unique email identifier may include an email address associated with a user of the third computing device and/or an email address associated with a user of a fourth computing device, where the user of the fourth computing device is designated as an emergency contact of the user of the third computing device.

In one example, computing device 40 may, subsequent to receiving the first communication and sending the second communication, receive a third communication (e.g., a textual communication or a multimedia message) from the third computing device (e.g., using a text messaging service and/or MMS). In one example, computing device 40 may convert the text/combined message thread to an email format conforming to one or more parameters received from an email server, a status message format conforming to one or more parameters received from a social networking server, text message format received from the text messaging service, and a format provided by the MMS. In this example, computing device 40 may output at a display device (e.g., one or more of output devices 50, the converted text/combined message thread. In various examples, the text messaging service may include SMS and/or a service that defines a maximum number of characters for a single textual communication (e.g., a text message). In various examples, the unique identifiers may include one or more of a telephone number, a short code, and a saved contact identifier that is accessible via computing device 40.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium encoded with instructions. Instructions embedded or encoded in an article of manufacture including an encoded computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable storage media. Additional examples of computer readable medium include computer-readable storage devices, computer-readable memory, and tangible computer-readable medium. In some examples, an article of manufacture may comprise one or more computer-readable storage media.

In some examples, computer-readable storage media and/or computer-readable storage devices may comprise non-transitory media and/or non-transitory devices. The term “non-transitory” may indicate that the storage medium is tangible and is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
receiving, by a first computing device using one or more messaging services that allow an exchange of messages, a first communication sent from a second computing device, wherein the one or more messaging services comprise a text messaging service and multimedia message service (MMS), and wherein the first communication is selected from at least one of a text message processed by the text messaging service and a multimedia message processed by the multimedia message service (MMS);
sending, by the first computing device and to the second computing device, a second communication using the one or more messaging services, wherein the second communication is processed by at least one of the text messaging service and the MMS;
receiving, by the first computing device, a user input that indicates a desired length of a combined message thread;
combining, by the first computing device, the first communication and the second communication to form the combined message thread, wherein the combined message thread does not exceed the desired length indicated in the user input;
sending, by the first computing device, the combined message thread to a third computing device;
receiving, by the first computing device, a third communication sent from the third computing device;
adding, by the first computing device, the third communication to the combined message thread; and
sending, by the first computing device, subsequent outgoing communications of the combined message thread both to the second computing device and to the third computing device.

2. The method of claim 1, wherein sending the combined message thread to the third computing device comprises:
generating, by the first computing device, an electronic mail (email) message comprising a graphical representation of the combined message thread; and
sending the email message from the first computing device to an email server, wherein the email message is addressed to a unique email identifier associated with a user of the third computing device.

3. The method of claim 1, wherein sending the combined message thread to the third computing device comprises:
generating, by the first computing device, at least one graphical representation of the combined message thread; and
sending the at least one graphical representation from the first computing device to a server that hosts a social networking service.

4. The method of claim 3, wherein sending the at least one graphical representation to the server that hosts the social networking service comprises sending the at least one graphical representation from a user account associated with the first computing device, indicating that the social networking server is to display the at least one graphical representation in association with the user account.

5. The method of claim 4, wherein sending the at least one graphical representation to the server that hosts the social networking service further comprises:
selecting, by the first computing device, a subset of contacts from a plurality of contacts associated with the user account, wherein each contact of the plurality of contacts is associated with a separate user account; and
sending an instruction to the social networking server to display the at least one graphical representation to only the selected subset of contacts.

6.-7. (canceled)

8. The method of claim 1, wherein the user input indicates the desired length as a maximum number of communications in the combined message thread.

9. The method of claim 1, wherein the user input indicates the desired length as a timeline comprising a cut-off date associated with an oldest desired communication in the combined message thread.

10. The method of claim 1, wherein sending the combined message thread to the third computing device comprises sending, by the first computing device and to the third computing device, a third communication processed by at least one of the text messaging service and the MMS, the method further comprising:
sending, by the first computing device, an electronic mail (email) message to an email server that is communicatively coupled to the third computing device, wherein the email message comprises a graphical representation of the text message thread, and wherein the email message is addressed to a unique email identifier associated with a user of the third computing device.

11. The method of claim 10, wherein sending the email message to the email server comprises:
determining, by the first computing device, whether the third communication was sent successfully to the third computing device within a predetermined time limit; and
responsive to determining that the third communication was not sent successfully within the predetermined time limit, sending the email message to the email server.

12. The method of claim 10, wherein the unique email identifier comprises at least one of 1) an email address associated with a user of the third computing device, and 2) an email address associated with a user of a fourth computing device, wherein the user of the fourth computing device is designated as an emergency contact of the user of the third computing device.

13. The method of claim 1, wherein the first computing device, the second computing device, and the third computing device are associated with a first unique identifier, a second unique identifier, and a third unique identifier, respectively, wherein the first unique identifier, the second unique identifier, and the third unique identifier are all different from one another, and wherein each of the first unique identifier, the second unique identifier, and the third unique identifier comprises at least one of a telephone number, a short code, and a saved contact identifier that is accessible via the first computing device.

14. The method of claim 1, wherein the text messaging service comprises at least one of 1) a short message service (SMS) and 2) a text messaging service that defines a maximum number of characters for a single textual communication.

15. (canceled)

16. The method of claim 1, further comprising:
converting, by the first computing device, the combined message thread to one of 1) an electronic mail (email) format conforming to one or more parameters received from an email server, 2) a status message format conforming to one or more parameters received from a social networking server, and 3) a text message format received from the text messaging service; and
outputting, at a display device coupled to the first computing device, the converted combined message thread.

17. A computer-readable storage device encoded with instructions that, when executed, cause one or more processors of a first computing device to perform operations comprising:
receiving, using one or more messaging services that allow an exchange of messages, a first communication sent from a second computing device, wherein the one or more messaging services comprise a text messaging service and multimedia message service (MMS), and wherein the first communication is selected from at least one of a text message processed by the text messaging service and a multimedia message processed by the multimedia messaging service (MMS);
sending, to the second computing device, a second communication using the one or more messaging services, wherein the second communication is processed by at least one of the text messaging service and the MMS;
receiving a user input that indicates a desired length of a combined message thread;
combining the first communication and the second communication to form the combined message thread, wherein the combined message thread does not exceed the desired length indicated in the user input;
sending the combined text message thread to a third computing device;
receiving a third communication sent from the third computing device;
adding the third communication to the combined message thread; and
sending subsequent outgoing communications of the combined message thread both to the second computing device and to the third computing device.

18. A computing device comprising:
a communication interface; and
one or more programmable processors configured to:
receive, via the communication interface using one or more messaging services that allow an exchange of messages, a first communication sent from a second computing device, wherein the one or more messaging services comprise a text messaging service and multimedia message service (MMS), and wherein the first communication is selected from at least one of a text message processed by the text messaging service and a multimedia message processed by the multimedia message service (MMS);
send, via the communication interface, a second communication to the second computing device, wherein the second communication is processed by at least one of the text messaging service and the MMS;
receive a user input that indicates a desired length of a combined message thread;
combine the first communication and the second communication to form the combined message thread, wherein the combined message thread does not exceed the desired length indicated in the user input;
send, via the communication interface, the combined message thread to a third computing device;
receive, via the communication interface, a third communication sent from the third computing device;
add the third communication to the combined message thread; and
send, via the communication interface, subsequent outgoing communications of the combined message thread both to the second computing device and to the third computing device.

19. The computing device of claim 18, wherein the one or more programmable processors are further configured to:
generate an electronic mail (email) message that provides a visual representation of the combined message thread; and
send, via the communication interface, the combined message thread to the third computing device at least in part by sending the email message to an email server, wherein the email message is addressed to a unique email identifier associated with a user of the third computing device.

20. The computing device of claim 19, wherein the email message further comprises audio data.

21. The computing device of claim 18, wherein the one or more programmable processors are further configured to:
generate at least one visual representation of the combined message thread; and
send, via the communication interface, the combined message thread to the third computing device at least in part by sending the at least one visual representation to a social networking server that hosts a social networking service.

22. The computing device of claim 21, wherein the one or more programmable processors are further configured to:
send, via the communication interface, the at least one visual representation to the social networking server at least in part by sending the at least one visual representation from a user account associated with the computing device, indicating that the social networking server is to display the at least one visual representation in association with the user account.

23. The computing device of claim 22, wherein the one or more programmable processors are further configured to:
select a subset of contacts from a plurality of contacts associated with the user account, wherein each contact of the plurality of contacts is associated with a separate user account; and
send, via the communication interface, the at least one visual representation to the social networking server at least in part by sending an instruction to the social networking server to provide access to the at least one visual representation only by the selected subset of contacts.

24.-25. (canceled)

26. The computing device of claim 18, wherein the user input indicates a maximum number of messages that are to be included in the combined message thread.

27. The computing device of claim 18, wherein the user input indicates a cut-off date associated with an oldest desired message in the combined message thread.

28. The computing device of claim 18, wherein the one or more programmable processors are further configured to:
send, via the communication interface, the third communication to the third computing device using at least one of the text messaging service and the MMS; and
send a backup electronic mail (email) message to an email server that is communicatively coupled to the third computing device, wherein the backup email message provides a visual representation of the combined message thread, and wherein the backup email message is addressed to a unique email identifier associated with a user of the third communication device.

29. The computing device of claim 28, wherein the one or more programmable processors are further configured to:
determine whether the third communication was sent successfully to the third computing device within a predetermined time limit; and
responsive to determining that the third communication was not sent successfully to the third computing device within the predetermined time limit, to send the backup email message to the email server.

30. The computing device of claim 28, wherein the unique email identifier comprises at least one of 1) an email address associated with a user of the third computing device, and 2) an email address associated with a user of a fourth computing device, wherein the user of the fourth computing device is designated as an emergency contact of the user of the third computing device.
